(19) United States
(12) Patent Application Publication
(10) Pub. No.: US 2012/0186251 A1
(43) Pub. Date: Jul. 26, 2012

(54) SOLAR POWER PLANT

(75) Inventors: Michael Epstein, Rishon LeZion (IL); Akiba Segal, Rehovot (IL)

(73) Assignee: YEDA RESEARCH AND DEVELOPMENT CO. LTD., Rehovot (IL)

(21) Appl. No.: 13/394,695

(22) PCT Filed: Sep. 2, 2010
(86) PCT No.: PCT/IL2010/000723

§ 371 Date: Apr. 11, 2012

(30) Foreign Application Priority Data
Sep. 10, 2009 (US) 61241057

(51) Int. Cl. F03G 6/06; F24J 2/38; F24J 2/18; F24J 2/24

(52) U.S. Cl. 60/641.11; 60/641.15; 126/663; 126/600; 126/685

(57) ABSTRACT

The present invention provides a novel solar steam generator comprising solar steam boiler compartment carrying water surrounding an internal superheater compartment. The boiler compartment is exposed to a first concentrated solar radiation. The boiler compartment is configured and operable to heat water to saturated temperatures and generate saturated steam. The boiler compartment operates as an integrated cavity enclosing the superheater compartment, reducing the thermal losses of the superheater compartment to the outside environment and absorbs most of the thermal losses of the superheater compartment. The internal superheater compartment is exposed to a second concentrated solar radiation and is configured and operable to superheat the saturated steam generated in the boiler compartment. The boiler compartment and the superheater compartment are thus arranged one with respect to the other such that the boiler compartment surrounds the internal superheater compartment.

### FIELD OF THE INVENTION

This invention is in the field of solar power plant technology, in particular a solar power tower structure and solar steam generators.

### REFERENCES

The following references are considered to be pertinent for the present invention:

1 A. Segal and M. Epstein, Solar Energy, 69 (suppl.), (2001), 229

2 A. Segal and M. Epstein, J. Solar Energy Engineering, 130, (2008), 011009

### BACKGROUND OF THE INVENTION

Solar power plants typically include solar collectors, such as a field of heliostat mirrors, which concentrate reflected sunlight on a number of receptors mounted on towers. A certain type of fluid is heated in the receptor and connected to a steam turbine type power block. The solar heat receptor cavity has generally a number of water or steam carrying tubes therein. A portion of the tubes (i.e. the boiling section) operates at a boiling temperature range suitable for heating boiler water and another portion of the tubes (i.e. the superheating section) is at a higher superheating temperature which serves as a steam superheater.

Direct steam generation in “solar tower” technology was developed and demonstrated already in the 1970's in Barstow, Calif., where an external steam receiver/boiler was installed on top of a solar tower. The receiver was built of vertical tubes creating a large cylindrical shape boiler operating in a mode of “once-through”, namely sub-cooled water enters the bottom of the tubes, flows up, boils, and finally at the top part of the tubes the saturated steam is superheated. Usually, the steam pressure range is 80-150 bars and the saturated steam temperature is therefore 296-343° C. respectively. A typical superheating temperature is around 200° C. above the saturated temperatures, namely at 500-550° C.

However, the superheating section operating in the once-through mode could not use any concentrated solar radiation until enough steam was generated at the boiling section. Therefore, the focusing strategy of the field was complicated. Also, the metal surface temperature of the superheating section was at least 50° C. above the steam inside, typically at 550-650° C., at which radiation losses outside became substantial. In addition, due to changes in solar intensity is during the day, the wetted sections in the tubes (e.g. region of two-phase flow) could become dry and suffer from overheating.

This approach was therefore replaced later by separating the superheating section from the boiling section. A typical solar thermal generation system of this type is illustrated in FIG. 1 and consists of a traditional steam Rankine cycle. In the system illustrated in FIG. 1, solar radiation is collected by a field of heliostats and transferred to heat water, in a solar boiler. The steam produced in the boiler is thereafter further heated in one or more superheaters and is then used to generate electricity by driving a turbine and electric generator or a combination of them, such as a steam turbine electric generator. The boiling section can be operated in a recycling mode where only part of the water, e.g. 10% is evaporated, separated in a steam drum, and the liquid water is recycled, mixed with the addition of make-up of water to compensate for the steam exiting the system. This approach prevents both the boiler tubes and the superheating tubes from drying out and overheating. Such superheating can be achieved separately, either with solar energy or with fossil fuel.

### GENERAL DESCRIPTION

Steam systems used in combination with solar towers are known. Such steam systems comprise solar receivers in which the boiling section and the superheating sections are configured as two separate adjacent elements, each placed inside an insulated cavity to reduce thermal losses. By using such configuration, the thermal losses of the boiling section are relatively small. Typically the surface temperatures of such boiling sections are in the range of about 400-450° C.

It should be understood, that conventionally, the insulated cavity has an to aperture through which the concentrated radiation enters, diverges inside the cavity and strikes the boiler tubes. The cavities are insulated enclosures, made of metal casing internally insulated, and the tube panels are installed inside, usually along the walls of the cavity. The cavity is costly and also suffers from radiation spillage around the aperture stemming from side heliostats in the field and from the changes in size of the solar image at various times of the day. Also, the cavity has a limited view angle, and therefore can match only a section of a surrounding heliostat field. Therefore, a single cavity can operate only with a specific limited field e.g. north field (in the northern hemisphere) or several cavities should be installed in a large commercial size plant to face different parts of the surrounding heliostat field. This results in operating conditions which are not uniform and which exist in each of the cavities and vary during the daily hours. Also, the cavity walls have to warm up every morning, which increases the startup time of the steam system.

Moreover, in such systems, it is not feasible technically and economically, to store superheated steam for later use during hours when the sun is not available. Even if the steam system is designed with thermal storage, the steam produced during the sunny hours has to exchange heat (through a first heat exchanger) to other storage mediums, e.g. molten salt (for example, eutectic mixture of sodium and potassium nitrates). During the time when the sun is not available, heat stored in the storage medium is extracted through a second heat exchanger to generate steam at inferior conditions because of temperature losses in each of these heat exchangers. Therefore, there is a need to provide a solar steam generator system having increased thermal efficiency.

The present invention provides a novel solar steam generator comprising a solar steam boiler compartment carrying water surrounding an internal superheater compartment. The boiler compartment is exposed to a first concentrated solar radiation. The boiler compartment is configured and operable to heat water to saturated temperatures and generate saturated steam. The boiler compartment operates as an integrated cavity enclosing the superheater compartment, reducing the thermal losses of the superheater compartment to the outside environment and absorbs most of the thermal losses of the superheater compartment. The internal superheater compartment is exposed to a second concentrated solar radiation and is configured and operable to superheat the saturated steam generated in the boiler compartment. The boiler compartment and the superheater compartment are thus arranged one with respect to the other such that the boiler compartment surrounds the internal superheater compartment. The boiler compartment therefore protects the superheater compartment from thermal losses from the environmental conditions, absorbs its thermal losses and thus increases the thermal efficiency of the solar steam generator. The solar steam generator of the present invention therefore provides effective solar energy collection (i.e. spillage losses of one compartment are used by the other and on the other hand reduces the thermal losses owing to the heat exchange between the concentric compartments. This configuration enables preheating of the superheater compartment by the boiler compartment during the start-up time, economical saving by eliminating the construction of insulated cavities enclosures in the state-of-the-art solar boilers and allows for effective energy storage.

It should be understood that as described above, typically a solar steam generator comprises a cavity surrounding the superheater compartment and/or the boiler compartment to reduce thermal losses. By using the configuration of the present invention, the steam generator does not include a conventional cavity surrounding the superheater compartment as an additional separate element. The boiler compartment reduces the thermal losses of the superheater compartment and therefore operates as a cavity. The boiler compartment has an aperture facing a part of the heliostat field. The aperture in the boiler compartment is configured for supplying energy to the superheater compartment.

Therefore, the arrangement of the boiler and superheater compartments provides that the boiler compartment is configured such that the boiler compartment operates as an integrated cavity reducing thermal losses and startup time of the superheater compartment. The startup time of the superheater refers to the initialization period of time that the steam generator goes through until the creation of superheated steam.

In some embodiments, the boiler compartment comprises an aperture through which the superheater compartment is exposed to the second concentrated radiation. It should be understood that when the steam process starts from cold water, the production of steam at 100 bars, requires an enthalpy of the water at the boiling point (312° C.) of 1.41 MJ/kg, and an evaporation enthalpy of 1.31 MJ/kg (the total enthalpy of the superheated steam at 100 bars and at 512° C. is 3.4 MJ/kg). Therefore, the superheating requires about 25% of the total enthalpy for the production of the saturated steam.

In some embodiments, the superheater compartment is configured as a second open cylinder embedded/surrounded with/by the cavity of the boiler compartment. The superheater compartment includes a plurality of open tubes. A part of the heliostat field, e.g. the north part, is configured to affect the superheating. It is operated when enough saturated steam is produced in the boiler compartment.

It should be noted that light spillage rays that strike around the superheating aperture (the solar radiation inside the collection angle of the superheater compartment, not entering into the aperture) is not lost (as usually occurring in conventional systems) but rather strikes the boiler compartment. Also, when heated up in the morning, the boiler compartment warms up gradually and warms, indirectly, the internal superheating tubes to the boiler temperature, and thus shortens the superheater compartment startup time in a safe manner. Therefore, the arrangement of the boiler and superheater compartments is configured such that the boiler compartment exploits light spillage of the second concentrated solar radiation and heats the internal superheater compartment during the start-up time.

In some embodiments, the solar steam generator comprises a steam drum configured and operable to separate the phases of the saturated steam/water mixture.

The solar steam generator may also comprise recycling pumps placed between the steam drum and the boiler compartment to enable the operation of the boiler compartment in a recycle mode.

In some embodiments, the solar steam boiler compartment comprises an array of tubular water members (pipes) arranged along a first arc-like path defining an aperture through which the superheater compartment is exposed to the second concentrated radiation. The first arc-like path is exposed to the first concentrated solar radiation enabling heating of the tubular water members. The first arc-like path defines an inner space accommodating the internal superheater compartment, thus enabling heat exchange between the boiler compartment and the superheater compartment. The superheater compartment comprises an array of tubular steam members arranged along a second arc-like path. The second arc-like path defines an aperture through which the tubular members are exposed to the second concentrated solar radiation enabling heating of the tubular steam members.

In some embodiments, the first arc-like path and the second arc-like path define a common aperture.

In some embodiments, at least one of said first and second arc-like paths defines substantially semi-cylindrical geometrical circumferences.

In some embodiments, the arrangement of the boiler and superheater compartments is concentric.

In some embodiments, the arrangement of the boiler and superheater compartments is configured such that the boiler compartment and the superheater compartment are exposed to spatially separated first and second concentrated light portions having substantially non-overlapping solid-angle sectors of radiation focusing towards (incident on) the solar steam generator. The boiler and superheater compartments are exposed to radiations propagated from different directions.

In some embodiments, the internal superheater compartment is operable at a temperature of typically about 200° C. above saturated temperatures (but not limited to) and/or at superheating temperatures in the range of about 500-550° C.

The steam generator of the present invention is therefore an integrated superheater/boiler arrangement assuring high thermal efficiency, low thermal losses from the hotter superheater compartment, shorter startup time and better optical efficiency. The heliostat field reflects the solar radiation toward the steam generator. The solar radiation irradiating the steam generator is split between the boiler compartment, which usually occupies the majority of the field, and the superheater compartment.

According to another broad aspect of the present invention, there is provided a solar tower power structure comprising: a solar tower; a solar steam generator placed on top of the tower, and a heliostat field defined by controllably tracking heliostats arranged such that the field surrounds the steam generator. The heliostat field is configured and operable to reflect and concentrate solar radiation onto the steam generator in at least two radiation propagation sectors having predetermined directions. A first sector of the heliostat field is configured to focus a first part of the concentrated radiation onto a first arc-like path of the boiler compartment and a second sector of the heliostat field is configured to focus a second part of the concentrated radiation onto the superheater compartment through an aperture formed in the boiler compartment.

In some embodiments, there is provided a solar power plant comprising a solar steam boiler and a superheater configured as two concentric compartments of the same solar power receiver, such that the solar steam boiler and the superheater define a common energy collection surface. This on one hand provides effective solar energy collection (i.e. spillage losses of one compartment are used by the other, and on the other hand reduces thermal losses) owing to the heat exchange between the concentric compartments. This configuration also allows for effective energy storage, by using for example “beam down” optics.

The steam generator may be connected to a steam turbine power plant.

The solar steam generator is placed on a tower surrounded by a field of heliostats (tracking mirrors). A part of the field is configured for boiling the water and for generating steam and another part of the field is used for superheating the steam.

In some embodiments, the solar tower power structure comprises a reflector configured and operable to form beam-down optics and to reflect sunlight energy to the ground, and a ground receiver configured and operable to heat a storage medium for further generation of steam. The reflector is positioned to form beam-down optics. The ground receiver receives sunlight energy from the reflector. The beam-down system comprises inter alia three main components: a section of the heliostat field, the tower reflector and the ground receiver/secondary concentrator e.g. compound parabolic concentrator (CPC). The reflector causes the ray oriented to the aim point of the field to be reflected down to the receiver entrance located near the ground. Such beam-down optics can be configured and operable for ground storage. There are a number of configuration parameters, which connect the layout of the heliostat field, the size, location and inclination of the tower reflector, and the size and configuration of the array of the ground CPC elements. The sizing of the tower reflector is directly linked to the layout of the heliostat field and the geometry of the ground secondary concentrator. It depends on its position relative to the aim point of the field, amount of spillage around it, and the allowable solar flux striking the tower reflector. Its position influences the size of the image at the entrance plane of the ground CPC and the spillage around the CPC aperture. The spillage around the CPC is also directly related to the exit diameter of the CPC (equal to the entrance opening of the solar reactor, matching the CPC exit) and therefore linked to the input energy concentration, thermal losses, and working temperature in the steam generator.

In this case, the heliostat field is divided into three sectors. A first sector of the heliostat field is configured to focus the first part of the concentrated radiation onto the boiler compartment; a second sector of the heliostat field is configured to focus the second part of the concentrated radiation onto the superheater compartment; and a third sector of the heliostat field is configured to focus a third part of the concentrated radiation onto the tower reflector.

In some embodiments, the third sector of the heliostat field surrounds the tower in a circular manner.

In some embodiments, the heliostat field is configured to orient the solar radiation at a predetermined aim point on an external surface of the boiler compartment. Alternatively, the heliostat field is configured and operable to aim at different aim points along an external surface of the boiler compartment or on its main geometrical axis to provide substantially a uniform radiation flux on the external surface of the boiler compartment.

The solar radiation is then used to heat the storage medium directly. The storage medium is thus not heated by the steam via a heat exchanger. During the day, the superheated steam is directly generated in the tower's top receivers, and in the evening, the stored heat is extracted from the storage medium e.g. molten salt storage, for further generation of steam and for providing extra hours of operation. The direct heating of the storage medium saves heat exchanges, piping and temperature losses during the charging of the storage as done in state-of-the-art technology. In this case, a part of the heliostat field is dedicated to the storage of solar energy and its size depends on the desired number of storage hours. The storage unit is placed on the ground close to the tower base.

According to another broad aspect of the present invention, there is provided a method for steam generation. The method comprises: integrating a boiler compartment for water circulation therein with a superheater compartment for receiving saturated steam from the boiler compartment, and exposing the boiler compartment to solar radiation and exposing the superheater compartment to solar radiation through the boiler compartment, thereby enabling saturated steam to be generated in the boiler compartment, and upon reaching the desired saturated temperatures, to pass to the superheater compartment and to generate superheated steam in the superheater compartment upon reaching superheating temperatures. The saturated steam generated/produced in the boiler compartment is separated from the water circulating in the steam drum and is then transferred and flows into the superheater compartment for further heating and then is fed into the turbine.

In some embodiments, the method comprises at least partially embedding the superheater compartment inside the boiler compartment.

In some embodiments, the method comprises directing two portions of the solar radiation onto respectively the boiler and superheater compartments.

The method may comprise reflecting solar radiation by a heliostat field towards a reflector to thereby generate a concentrated reflected radiation, and directing the concentrated reflected radiation onto a ground receiver in which a storage medium is placed, to thereby provide thermal storage.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a simplified flow diagram of a solar thermal electricity generation system generally known in the art;

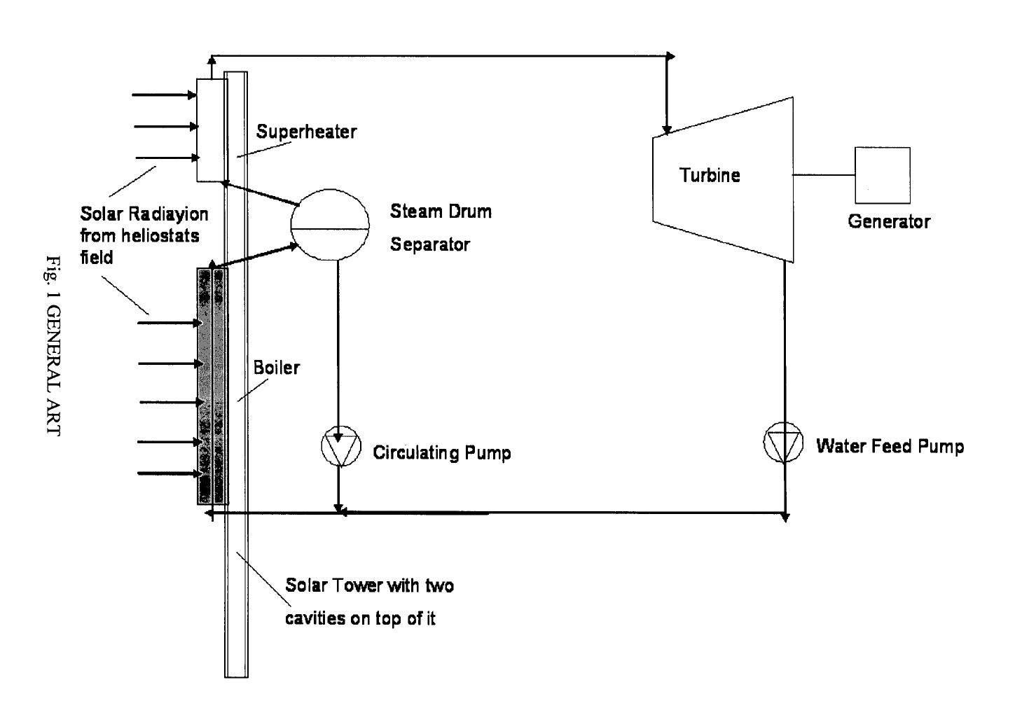

FIG. 2 is a simplified schematic view of an example of a configuration of the solar steam generator of the present invention;

FIG. 3 is a schematic layout of the heliostat field according to the teachings of the present invention; and;

FIG. 4 is a simplified schematic view of an example of a configuration of the solar tower power structure of the present invention.

### DETAILED DESCRIPTION OF EMBODIMENTS

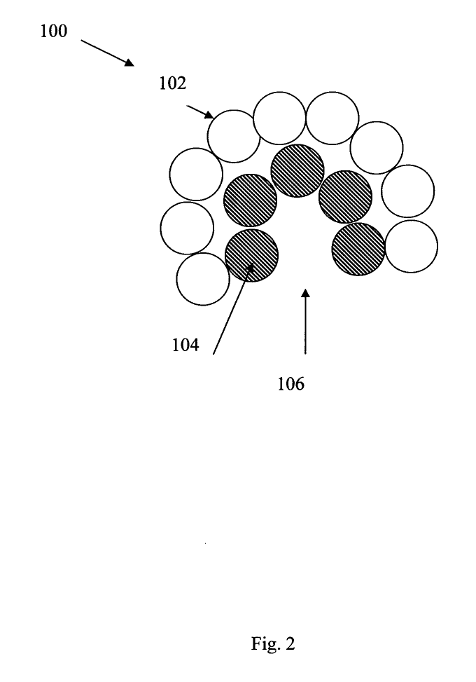

Reference is made to FIG. 2 exemplifying a solar steam generator 100 comprising an arrangement of a solar steam boiler and superheater compartments according to the invention. The arrangement is such that the compartments are actually integrated with one another such that the superheater compartment can be accessed by solar radiation/sunlight through an aperture in the boiler compartment, and the compartments are in desired heat exchange between them. The heat exchange is such that the superheater compartment (i.e. steam therein) is kept preheated by the boiler compartment (i.e. hot water/steam therein), while both the boiler and superheater compartments are exposed to solar radiation. More specifically, as shown in the figure, a solar steam boiler compartment 102 surrounds an internal superheater compartment 104. In this specific configuration, the boiler compartment 102 and the superheater compartment 104 are arranged in a concentric arrangement. The solar steam generator 100 has one or more apertures 106 through which sunlight, as deflected/reflected and concentrated by tracking heliostats mounted on the ground, is directed. The boiler compartment 102 comprises a plurality of tubular elements and operates as an external cylindrical receiver in which concentrated solar radiation enters through aperture(s) 106. The superheater compartment 104 comprises a plurality of tubular elements and operates as a cavity receiver in which concentrated solar radiation enters through aperture 106 defined by the boiler/external receiver 102. The boiler/external receiver 102 is configured and operable to boil water and generate saturated steam. The superheater/cavity receiver 104 is configured and operable to superheat the steam produced in the boiler/external receiver 102. The superheater compartment, being placed inside the boiler compartment, is therefore heated by the boiler walls, when the boiler compartment warms up. Therefore, the superheating temperature (500-550° C. i.e. surface temperatures of about 650° C.) is reached faster and more efficiently. As the boiler compartment/cavity is at saturated temperatures (surface temperature of about 400° C.), the thermal losses of the superheater compartment are minimal.

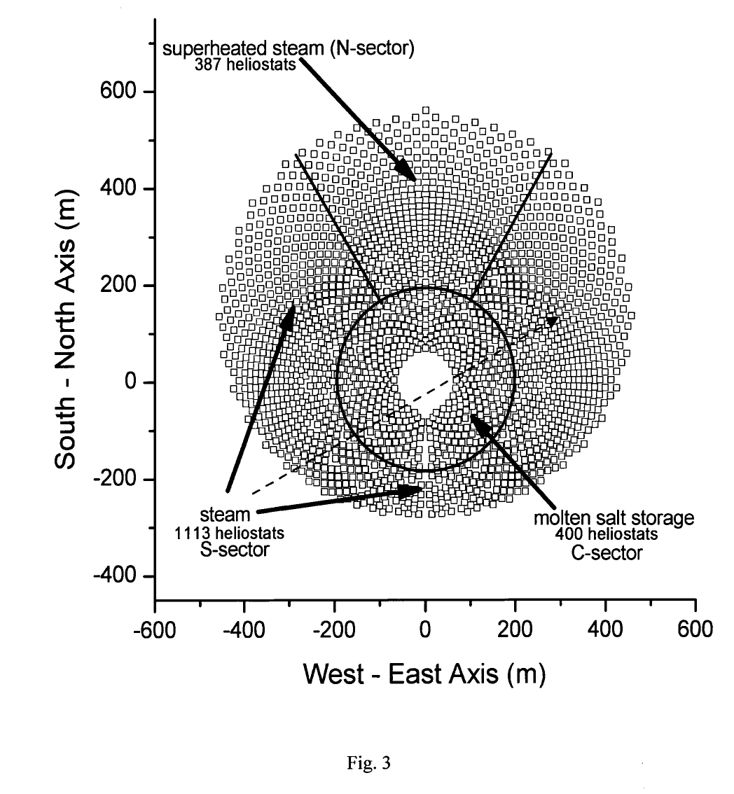

In a specific and non-limiting example, the boiler/external receiver 102 is composed of about 450 tubes, each having a diameter of 5 cm, forming a semi-cylinder (i.e. a part of its circumference is open) of a radius of about 5 m and height of about 8 m. The open part of the semi-cylinder faces a predetermined direction e.g. the north direction with an aperture of about 7.6 m width and 6 m height. The superheater compartment surrounded by the boiler compartment is shaped as an arc with a radius of about 4 m. The superheater compartment is composed of about 330 tubes, each having a diameter of about 5 cm and a height of about 8 m, forming a semi-cylinder. The aperture of the semi-cylinder faces a predetermined part of the heliostat field. In this connection, reference is made to FIG. 3 illustrating a non-limiting example of the heliostat field layout configured in accordance with the solar steam generator of the present invention. As illustrated in FIG. 3, to achieve the novel application of the steam generator of the present invention, the heliostat field is circular and is divided into at least two sectors optimizing the used part of the heliostat field and increasing the uniformity of operating conditions. The first sector, named S-sector is focused onto the boiler compartment and comprises 1113 heliostats. The second sector, named N-sector, is focused onto the superheater compartment. The second sector comprises 387 heliostats and is situated in the center—north part direction of the heliostat field, viewed from the origin of coordinates at a rim angle of 30° and is delimited between the radii of 180 m and 545 m respectively. The optional third sector, named C-sector, is focused onto a ground receiver for storage and completes the entire field shown in FIG. 3. The third sector comprises 400 heliostats, is circular, and surrounds the tower with a radius of 180 m.

In this specific and non-limiting example, the heliostat field is composed of 1900 heliostats. Each heliostat has a gross area of 100 m² and reflective surface of 95 m². This field has been optimized following the method described in [1] which is incorporated herein by reference, resulting in an elliptic field having a semiaxis of 420 m in the North-South direction and semiaxis of 460 m in the an East-West direction. The tower is located 140 m south of the ellipse center. The first row of heliostats is at 70 m distance from the tower.

The S-sector, comprising 1113 heliostats, collects and reflects about 64 MW (assuming direct insolation of 800 W/m², average cos φ=0.85, heliostat reflectivity 0.9, average shadowing 1%). The rays deflected by the heliostats are directed to an aim point taken at 138 m and hit the external boiler compartment. The average flux on this receiver (i.e. external circumference of the boiler compartment) is about 220 kW/m² and might have higher peaks incident on some zones/regions on the boiler compartment. In order to avoid this situation and provide substantially uniform radiation flux on the surface of the boiler compartment, the heliostats aim the reflected rays to variable aim points by dividing the S-sector in groups of heliostats having different aim points, namely different groups of heliostats focus the radiation on different locations along the boiler surface. The inventors have estimated that by using the configuration of the external boiler compartment as described above, the boiler compartment can absorb daily (at the design point) about 210 MWh that corresponds to a production of about 495.6 tons of saturated steam/day at 100 bars (boiling point 311.8° C.).

The solar radiation originated in the N-sector is dedicated to superheat the steam produced by the boiler compartment. The superheater compartment is placed inside the cavity formed by the external receiver. The aim-point of this group of heliostats has been calculated to be at 138 m on the tower axis. About 20.5 MW enter the cavity at the design point with a negligible amount of spillage. Being a cavity receiver, the calculus is more complicated, because radiation heat exchange inside a cavity occurs. Following these calculations, the daily energy absorbed in the superheater receiver is about 123 MWh. This amount of energy superheats the above amount of saturated steam to 550° C. (degrees superheat of 238.2° C.) assuming 85% thermal efficiency of the superheater compartment.

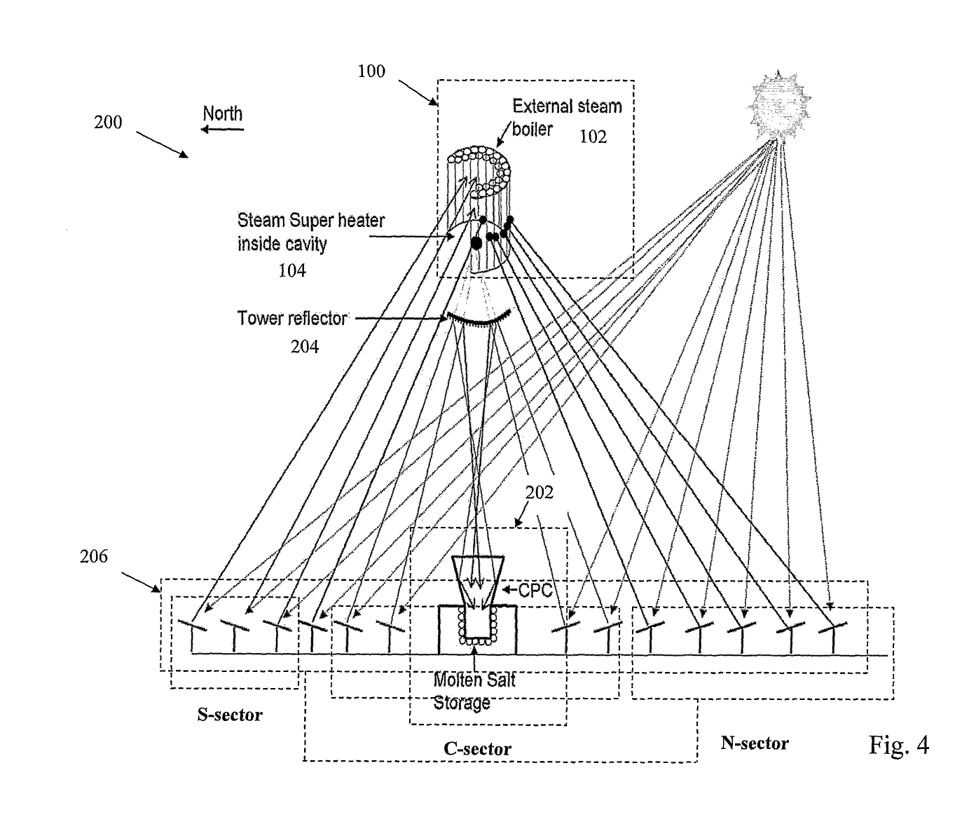

Reference is made to FIG. 4 illustrating an example of a configuration of the solar tower power structure. In this connection, it should be noted that the solar tower power structure of the present invention provides a novel configuration. Such solar tower power structure may be a stand-alone device or may be mounted with any steam generator of any type if needed including the configuration of the present invention. There is provided a novel solar tower power structure 200 comprising a solar tower (not shown), the steam generator which may be as described above placed in the upper part of the tower, and a field of tracking heliostats 206 mounted on the ground and surrounding the steam generator 100.

In some embodiments, the solar tower power structure 200 comprises a reflector 204 configured and operable to generate beam-down optics and a ground receiver 202 configured and operable to heat a storage medium (e.g. molten salt) pumped through it to a hot storage tank, and to receive concentrated sunlight from the reflector 204, in order to continue operating a number of hours after sunset. The ground receiver 202 collects the rays reflected by a tower reflector 204 as described by [2] and incorporated herein by reference. Generally, the tower reflector is an optical system comprising a quadric surface mirror (hyperboidal or ellipsoidal), where its upper focal point coincides with the aim point of a heliostat field and its lower focal point is located at a specified height, coinciding with the entrance plane of the ground receiver. In this specific but non-limiting example, the tower reflector 204 is situated at a height of 118 m and having a hyperboloid shape with radius of 24.2 m and a total area of 1595 m². The beams from the heliostats are reflected downward by the reflector situated below their aim point. The calculations take into assumption a solar power tower structure producing power of 100 MW.

The ground receiver 202 comprises a compound parabolic concentrators (CPC) cluster. In the ground receiver 202, the molten salt is heated from 250° C. to 550° C. and is used for thermal storage. Therefore, this configuration directly uses solar radiation for a storage medium and eliminates the need to use heat exchanger(s).

The power entering the ground receiver at the design point is 19.5 MW (for this specific example). On a designated day, the ground receiver can absorb about 120 MWh, meaning about 3 hours of storage.

In a specific and non-limiting example, the ground receiver 202 is configured as a cavity having at its ceiling, a plurality of apertures (e.g. of 1.6 m diameter), endowed with compound parabolic concentrators (CPC). Each CPC can have a hexagonal cross section at its entrance with an area of 37 m² and a height of about 15 m (CPC truncated).

As illustrated in the figure, the S-sector is focused onto the boiler compartment the N-sector is focused onto the superheater compartment and the C-sector is oriented to an aim point at 140 m. The rays intersect the reflector 204 (e.g. hyperboloid mirror).

1. A solar steam generator comprising:
a solar steam boiler compartment carrying water, said boiler compartment being exposed to a first concentrated solar radiation and configured and operable to heat water to saturated temperatures and generate saturated steam; and
an internal superheater compartment exposed to a second concentrated solar radiation and configured and operable to superheat said saturated steam generated in the boiler compartment, said boiler compartment and said superheater compartment being arranged one with respect to the other such that said boiler compartment surrounds the internal superheater compartment, the boiler compartment therefore absorbs thermal losses from the superheater compartment thereby increasing thermal efficiency of the solar steam generator.

2. The solar steam generator of claim 1, wherein the arrangement of the boiler and superheater compartments is configured such that the boiler compartment operates as an integrated cavity enclosing the superheater compartment, reducing thermal losses and start-up time of the superheater compartment.

3. The solar steam generator of claim 1, wherein said boiler compartment comprises an aperture through which said superheater compartment is exposed to said second concentrated radiation.

4. The solar steam generator of claim 1, wherein the arrangement of the boiler and superheater compartments is configured such that the boiler compartment exploits light spillage of the second concentrated solar radiation around the aperture of the boiler compartment.

5. The solar steam generator of claim 1, wherein said solar steam boiler compartment comprises an array of tubular water members arranged along a first arc-like path defining an aperture through which said superheater compartment is exposed to said second concentrated radiation.

6. The solar steam generator of claim 5, wherein said first arc-like path is exposed to said first concentrated solar radiation enabling heating of the tubular water members.

7. The solar steam generator of claim 5, wherein said first arc-like path defines an inner space accommodating said internal superheater compartment and thus enabling heat exchange between said boiler compartment and said superheater compartment.

8. The solar steam generator of claim 1, wherein said superheater compartment comprises an array of tubular steam members arranged along a second arc-like path; said second arc-like path defining an aperture through which said tubular members are exposed to said second concentrated solar radiation enabling heating of the tubular steam members.

9. The solar steam generator of claim 8, wherein said first arc-like path and said second arc-like path define a common aperture.

10. The solar steam generator of claim 5, wherein at least one of said first and second arc-like paths defines substantially a semi-cylindrical geometrical circumference.

11. The solar steam generator of claim 1, wherein the arrangement of the boiler and superheater compartments is concentric.

12. The solar steam generator of claim 5, wherein the arrangement of the boiler and superheater compartments is configured such that the boiler compartment and the superheater compartment are exposed to spatially separated first and second light portions of substantially non-overlapping solid-angle sectors of radiation focusing on said solar steam generator.

13. The solar steam generator of claim 12, wherein the boiler and superheater compartments are exposed to radiation propagated from different directions.

14. The solar steam generator of claim 1, wherein said internal superheater compartment is operable at a temperature of about 200° C. above saturated temperatures.

15. The solar steam generator of claim 1, wherein said internal superheater compartment is operable at superheating temperatures in the range of about 500-550° C.

16. A solar tower power structure comprising:
a solar tower; a solar steam generator configured as claimed in claim 1; said solar steam generator being placed on top of said tower, and;
a heliostat field formed by controllably tracking heliostats arranged such that the heliostat field surrounds said steam generator; said heliostat field is configured and operable to reflect and concentrate solar radiation onto said steam generator in at least two radiation propagation sectors having predetermined directions; a first sector of the heliostat field being configured to focus a first part of the concentrated radiation onto a first arc-like path of the boiler compartment and a second sector of the heliostat field being configured to focus a second part of the concentrated radiation onto the superheater compartment through an aperture formed in the boiler compartment.

17. A solar tower power structure comprising:
a solar tower;
a solar steam generator placed on top of said tower; said solar steam generator comprises a boiler compartment and a superheater compartment, and
a heliostat field formed by controllably tracking heliostats, wherein the boiler compartment has an aperture forming a solar radiation path to the superheater compartment, said controllably tracking heliostats being arranged such that the field surrounds said steam generator; and said heliostat field is configured and operable to reflect and concentrate solar radiation onto said steam generator into at least two radiation propagation sectors having predetermined directions; a first sector of the heliostat field being configured to focus a first part of the concentrated radiation onto a first arc-like path of the boiler compartment and a second sector of the heliostat field being configured to focus a second part of the concentrated radiation onto the superheater compartment through the aperture formed in the boiler compartment.

18. The solar tower power structure of claim 16 comprising a reflector configured and operable to form beam-down optics and to reflect sunlight energy to the ground; and a ground receiver configured and operable to heat a storage medium for further generation of steam; said ground receiver receiving sunlight energy from said reflector.

19. The solar tower power structure of claim 18, wherein said heliostat field is divided into three sectors; a first sector of the heliostat field being configured to focus the first part of the concentrated radiation onto the boiler compartment; a second sector of the heliostat field being configured to focus the second part of the concentrated radiation onto the superheater compartment and a third sector of the heliostat field being configured to focus a third part of the concentrated radiation onto said reflector.

20. The solar tower power structure of claim 19, wherein said third sector of the heliostat field surrounds the tower in a circular manner.

21. The solar tower power structure of claim 16, wherein said heliostat field reflecting and concentrating solar radiation onto said steam generator is configured to orient the solar radiation at a predetermined aim point on an external surface of said boiler compartment.

22. The solar tower power structure of claim 16, wherein said heliostat field reflecting and concentrating solar radiation onto said steam generator is configured and operable to aim at different aim points along an external surface of said boiler compartment to provide a substantially uniform radiation flux on the external surface of the boiler compartment.

23. The solar tower power structure of claim 17, wherein said steam generator is connected to a steam turbine power block.

24. A method for steam generation comprising:
integrating a boiler compartment for water circulation therein with a superheater compartment, for receiving saturated steam from the boiler compartment; and exposing said boiler compartment to solar radiation and exposing said superheater compartment to the solar radiation through said boiler compartment, thereby enabling saturated steam to be generated in the boiler compartment, and upon reaching saturated temperatures, to pass to said superheater compartment and to generate superheated steam in said superheater compartment upon reaching superheating temperatures.

25. The method of claim 24, wherein said integrating of the boiler compartment with a superheater compartment comprises at least partially embedding the superheater compartment inside the boiler compartment.

26. The method of claim 24, comprising directing different portions of the solar radiation onto the boiler and superheater compartments respectively.

27. The method of claim 26, comprising reflecting solar radiation by a heliostat field towards a reflector to thereby generate concentrated reflected radiation,

28. The method of claim 27, comprising directing said concentrated reflected radiation onto a ground receiver in which a storage medium is placed to thereby provide thermal storage.

29. The method of claim 24, comprising separating said saturated steam, generated in the boiler compartment, from water circulating therein, and transferring said saturated steam into said superheater compartment
